(19) United States
(12) Patent Application Publication
(10) Pub. No.: US 2004/0194633 A1
(43) Pub. Date: Oct. 7, 2004

(54) Popcorn cooking device

(76) Inventor: Richard P. Bourne, Belgium, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/407,452

(22) Filed: Apr. 4, 2003

(51) Int. Cl. A23L 1/18

(52) U.S. Cl. 99/323.5

(57) ABSTRACT

A popcorn cooking includes a cooking receptacle for use over a heat source and a means for stirring popcorn contained within it. The stirring means consists of a single stirring rod inserted through the cover of the cooking receptacle. The stirring rod, in one embodiment, consists of a rod-like member, or stirring rod, descending generally vertically downwardly from a cover of the cooking receptacle toward the floor of the cooking receptacle. A second embodiment of the stirring rod provides for a unique “double bend” type rod design. A third embodiment of the stirring rod provides for a unique spring loaded stirring rod. And a fourth embodiment provides for V-shaped sweeping member.

### FIELD OF THE INVENTION

The present invention relates to cooking devices and the like. More specifically, it relates to an improved popcorn cooking device, which device includes one or more specialized stirring elements used within the popcorn cooking device for improving the cooking of popcorn contained within the device, and for improving the coating of already popped popcorn contained within the device, among other things.

### BACKGROUND OF THE INVENTION

Mankind has utilized cooking devices for just about as long as it has figured out that cooking improves the quality of some of the foods it eats. One particular food requires cooking in order for it to be consumed at all. And that food is this country's snack food of choice, popcorn. While many vendors of popcorn have simplified the accessibility of that food to the point that a consumer merely tosses a bag into the microwave and powers it up for a few minutes, there is still an allure to doing the popping of popcorn the old fashioned way. And that is by popping it over a stove or other heat source in a device that is specifically designed for that purpose. In the experience of these inventors, however, devices of this nature and of previous design have shortcomings.

For example, and as any person who has cooked popcorn over the burner of a stove in just a lidded metal pot is aware, the popcorn, once cooked or popped, is larger, less dense and has more surface area than its uncooked counterpart and tends to rise to the top of the metal pot. On the other hand, the uncooked popcorn kernel, which is smaller, denser and has less surface area, tends to stay at or fall to the bottommost surface of the pot. And this phenomenon is not limited just to lidded metal pots. When the unpopped kernels remain at the bottom of the metal pot, they are nearest the heat source where each kernel will, in theory, pop.

Unfortunately, and as those who have cooked popcorn over the burner of a stove are aware, this procedure works better in theory than in reality. The reality is that frequently uncooked kernels remain in the mix with popped kernels and both popped and unpopped kernels remain at the bottom of the metal pot, remaining there only to get inevitably burned. This produces a highly unsatisfactory odor in the cooking area and reduces the yield of edible popcorn.

For those who enjoy the fine art of cooking popcorn, as these inventors clearly do, an improved device for agitating popped and unpopped kernels is required. Accordingly, it is a first object of the device of the present invention to provide a popcorn popping device that is designed and constructed to recognize that overheating of the kernels occurs not only at the bottommost horizontal surface of the cooking device, but also up and along its sidewalls. It is another object of the present invention to provide such a device that includes a popcorn stirring rod that is simple to produce, is less complicated than like articles of similar manufacture and that may be interchanged with other rods. It is yet another object of the present invention to provide such a device whereby the popcorn stirring rod is configured in one embodiment to facilitate the coating of popcorn with flavorings or other foodstuffs as desired or required by the consumer.

### SUMMARY OF THE INVENTION

The popcorn cooking device of the present invention has met these objects. It provides for a cooking receptacle for use over a heating element or other heat source and includes a means for stirring the popcorn contained within it. The stirring means consists of a single stirring rod inserted through the cover of the cooking receptacle. The stirring rod, in one embodiment, consists of a rod-like member, or stirring rod, descending generally vertically downwardly from a cover of the cooking receptacle toward the floor of the cooking receptacle. Means are provided to rotate that portion of the stirring rod axially. At the area of a generally horizontally planar floor, the stirring rod is bent 90° outwardly in a plane that is parallel to the floor of the receptacle. That portion of the stirring rod continues across the floor of the receptacle such that, when the vertical portion of the stirring rod is rotated, the outwardly extending portion of the stirring rod slides along and just above the floor of the cooking receptacle. At the area of the upwardly extending circular sidewall of the cooking receptacle, the stirring rod is again upturned at its distal end to generally match the slope of the cooking receptacle sidewall. When the vertical portion of the stirring rod is rotated, the upturned distal end of the stirring rod sweeps along the side of the cooking receptacle. In this fashion, and if the stirring rod is rotated at the proper speed, the popcorn in the cooking receptacle is cooked uniformly and unburned.

A second embodiment of the stirring rod provides for a unique “double bend” type rod design. As with the previous embodiment, the stirring rod comprises a rod-like member that extends generally vertically downwardly from the lid of the cooking receptacle. The second embodiment of the stirring rod provides for a first open loop at a point that is about halfway down the rod to agitate the popcorn at approximately the middle of the cooking receptacle. This first open loop is generally formed by producing a bend of slightly greater than 90° in the stirring rod such that the rod extends outwardly toward the side of the receptacle. The loop is then formed by reverse bending the stirring rod generally downwardly at an angle slightly less than 180° and extending that portion of the stirring rod back toward the axial center of the cooking receptacle. The lower portion, or second half, of the loop is preferably in a distinct angular and elevational plane from the upper portion, or first half, of the loop such that two distinct surfaces are present to agitate the popcorn. The stirring rod then extends downwardly toward the bottom of the cooking receptacle and may either form the configuration of the first embodiment at its base or have yet another loop as described above. In either case, the bottom of the stirring shaft should sweep along the bottom of the cooking receptacle so that the cooked popcorn is moved away from the unpopped kernels.

A third embodiment of the stirring rod provides for a unique spring loaded stirring rod. This alternative embodiment provides for a stirring rod that extends downwardly towards the floor of the cooking receptacle similar to the first and second embodiments. However, this third embodiment provides for a helical spring that is attached to the end of the stirring rod. At the other end of the helical spring, or formed as a part of the helical spring, is a sweeping member that extends outwardly from the helical spring such that the sweeping member slides along or just above the floor of the cooking receptacle when the stirring rod is rotated. In this fashion, the helical spring offers both compression to hold the sweeping member near the bottom of the cooking receptacle and torsional stiffness such that the sweeping member rotates through the popped popcorn and circulates it upwardly and passes over the unpopped kernels, leaving them to pop at the bottom of the kettle. A fourth embodiment of the present invention would for a V-shaped sweeping member.

It should be understood from this disclosure that one or any plurality, or a combination, of the above features could be employed together or separately and still bring the device within the scope of the present invention. The foregoing and other features of the device of the present invention will be apparent from the detailed description that follows.

### BRIEF DESCRIPTION OF THE DRAWINGS

FIG. 1 is a top, front and right side perspective view of a popcorn cooking device constructed in accordance with the present invention.

FIG. 2 is the same view of the device illustrated in FIG. 1 and showing a lid portion in the open position.

FIG. 3 is an exploded top, front and right side perspective view of the device illustrated in FIG. 1 and showing a first embodiment of a stirring rod used with it.

FIG. 4 is an exploded top, front and right side perspective view of the device illustrated in FIG. 1 that shows a second embodiment of a stirring rod used with it.

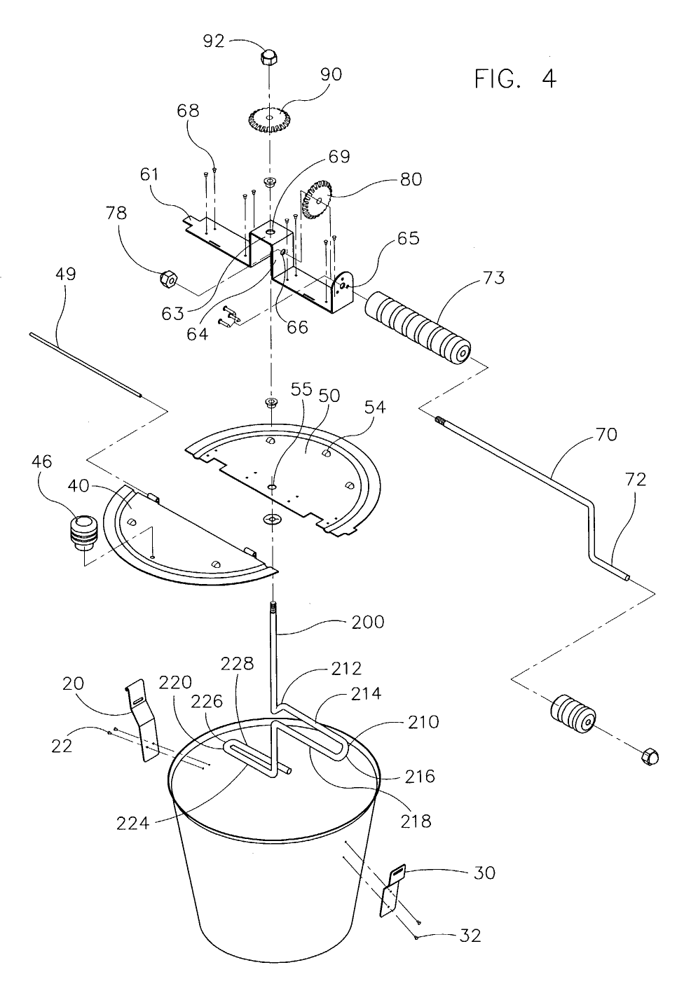

FIG. 5 is a cross-sectioned front elevational view of the device illustrated in FIGS. 1 and 3.

FIG. 6 is an enlarged partial top, front and right side perspective view of the device illustrated in FIG. 5 that shows details of the rod rotating mechanism.

FIG. 7 is the same view as FIG. 6 but illustrating the device having the stirring rod embodiment shown in FIG. 4.

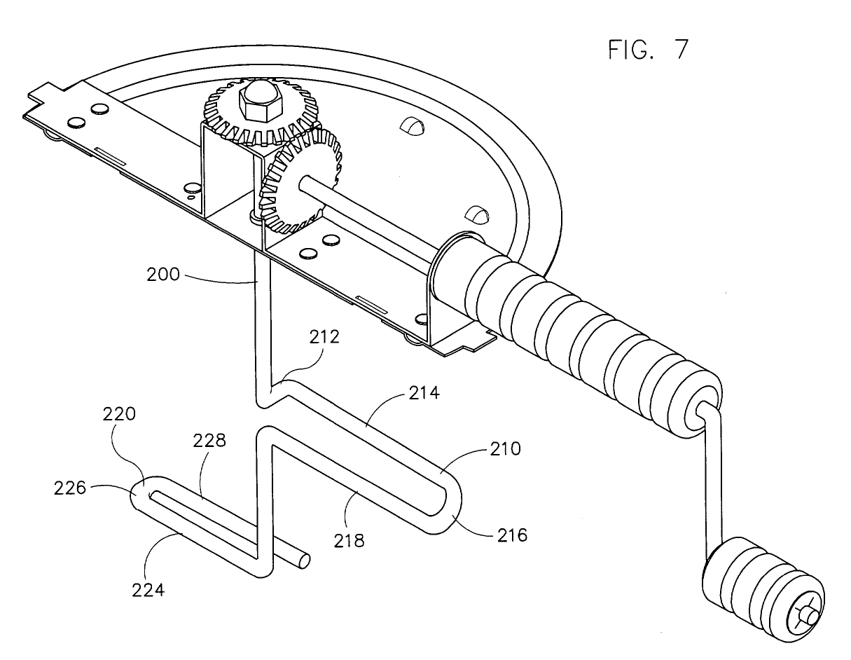

FIG. 8A is an exploded top, front and right side perspective view of the device illustrated in FIG. 1 and showing a third embodiment of the stirring rod.

FIG. 8B is a top, front and right side perspective view of the device illustrated in FIG. 8A that shows the third embodiment of the stirring mechanism in more detail.

FIG. 9A is an exploded top, front and right side perspective view of the device illustrated in FIG. 1 that shows a fourth embodiment of the stirring rod.

FIG. 9B is a top front and right side perspective view of the device illustrated in FIG. 9A that shows the stirring mechanism in more detail.

### DETAILED DESCRIPTION

The following detailed description is intended to describe the preferred embodiments that are depicted in the figures. It is to be understood that changes could be made to that which is specifically described and shown and which would still fall within the scope of the present invention.

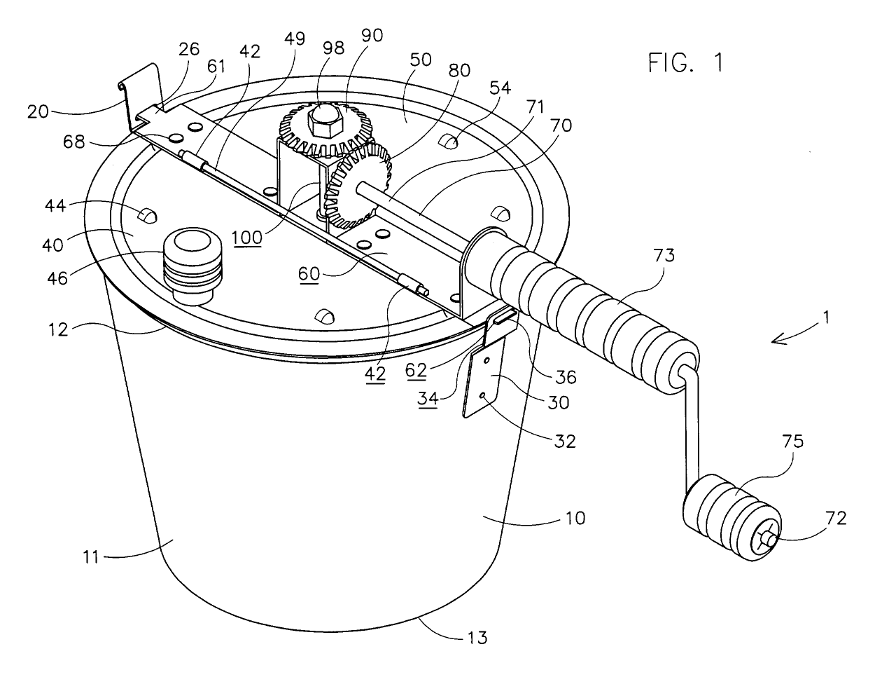

Referring now to the drawings in detail, wherein like numbered elements refer to like elements throughout, FIG. 1 illustrates one view of the popcorn popping device constructed in accordance with the present invention. That popcorn popping device is generally identified 1. As can be seen from FIG. 1, the popcorn popping device is generally comprised of a kettle, a lid, a stirring rod and a means for manually rotating the stirring rod.

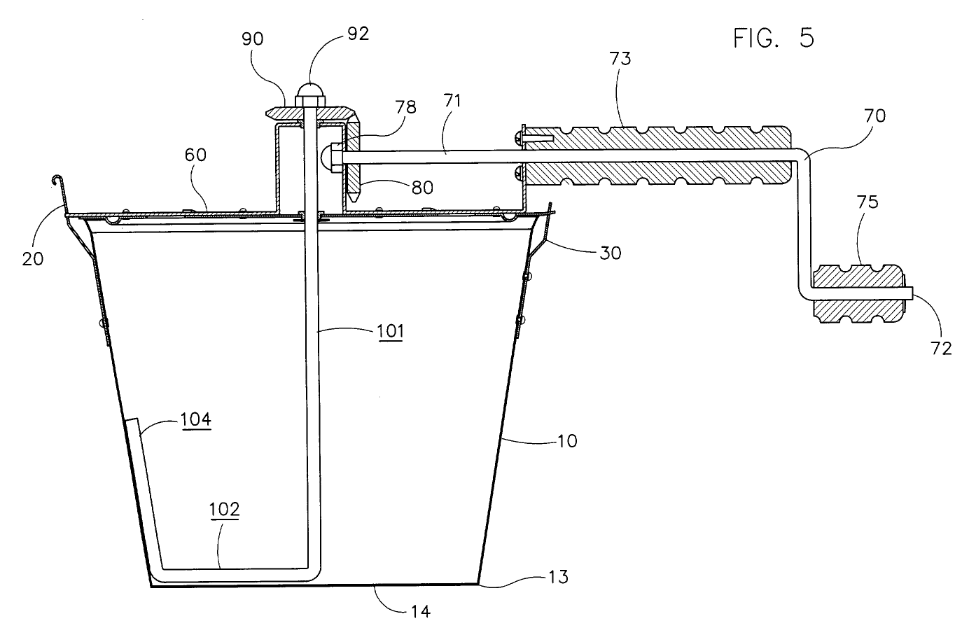

In the preferred embodiment, the kettle 10 is a generally cylindrical, but slightly invertedly conical, six quart stainless steel kettle, although other shapes, sizes and material of construction could be employed to produce the kettle contemplated herein. The slightly conical shaped kettle 10 includes a continuous kettle sidewall 11, a circular upper kettle opening 12 at the top of the kettle 10 and a circular kettle edge 13 at the bottom 14 of the kettle. See FIG. 5 also. The upper kettle opening 12 has a diameter that is slightly greater than that of the circular bottom kettle edge 13.

Positioned opposite each other near the top of the kettle 10 are a top retainer 30 and a top retainer spring 20. In a preferred embodiment, the top retainer 30 is a metal strip that is about 1/8 inch thick, 2¾ in long and ⅞ of an inch wide. The top retainer 30 is attached to the outside of the kettle 10 using rivets 32 or some other suitable fastener. At the uppermost portion 34 of the top retainer 30 is a slot 36. The importance of the slot 36 will become apparent later in this detailed description.

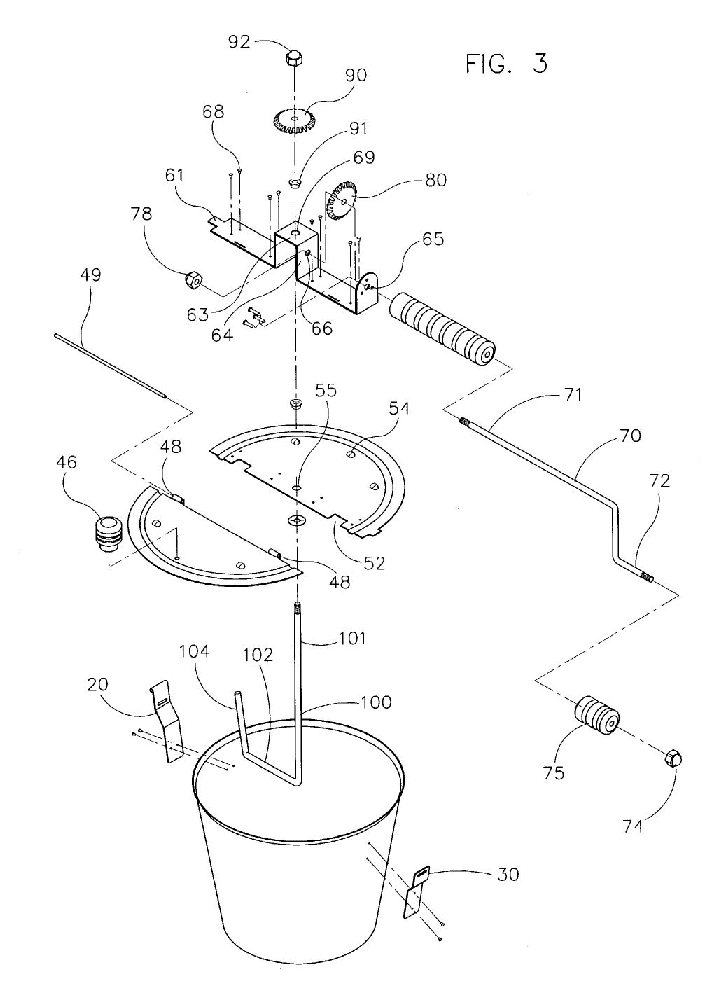

The top retainer spring 20 is attached to the kettle 10 using rivets 22 or some other suitable fastener at a point along the kettle 10 that is opposite the top retainer 30. See FIG. 3 also. In the preferred embodiment, the top retainer spring 20 is formed in generally the same shape as the top retainer 30 but is somewhat longer than the top retainer 20. The top retainer spring 20 also features a slot 26 equal in height to the slot 36 that is defined in the top retainer 30.

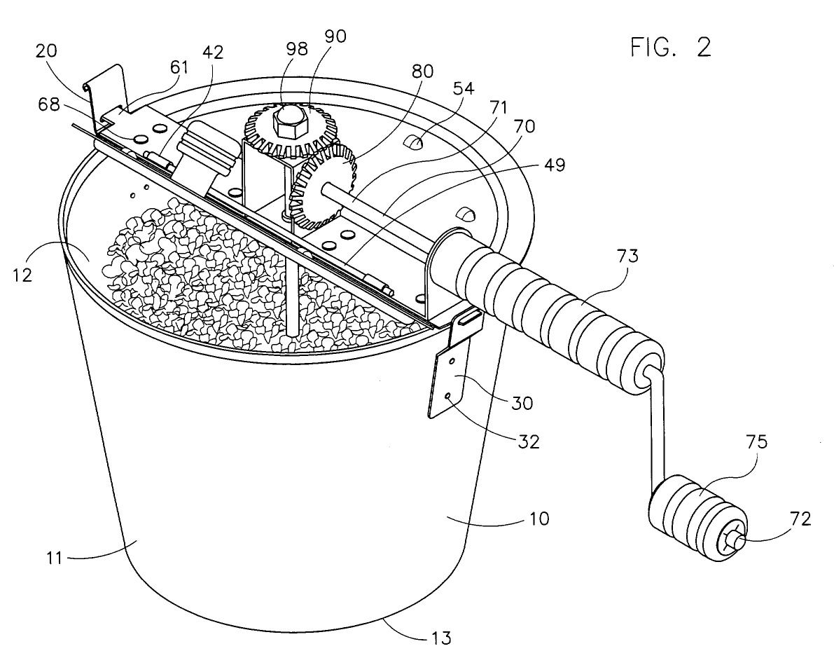

The lid 40, 50 of the kettle 10 is comprised of a two parts, one lid part 40 intended to be movable and one lid part 50 intended to be stationary during normal use of the device. See also FIG. 2. In the closed position, the lid portions 40, 50 lie within a generally horizontal plane. The moveable lid portion 40 is formed generally in the shape of a half circle. Along the diameter of the half circle are two tabs 42 that are formed to functionally act as lid hinges. In the preferred embodiment, the lid hinges extend ½ inch from the semicircle and are 1/2 inch wide. The moveable lid portion 40 also has a plurality of louvers 44 defined within it, each of which allows steam to escape from within the kettle. In the preferred embodiment, the moveable lid portion 40 also features a decorative knob 46 that is used to raise and lower the lid 40. The knob 46 can be made of nearly any heat insulating material, but these inventors prefer the aesthetic appeal of an oak knob 46.

The stationary lid portion 50 forms the other complementary half of the lid of the kettle 10. The stationary lid portion 50 is formed generally in the shape of a half circle and has two rectangular apertures 52 similar in shape, but slightly larger in size, to the tabs 42. See FIG. 3. The stationary lid 50 features a plurality of louvers 54 similar to those defined in the moveable lid 40. The stationary lid 50 also has an aperture 54 defined within it through which a portion of the stirring rod 100 extends.

In the preferred embodiment, the ends of the tabs 42 of the moveable lid portion 40 are curled underneath to form a generally cylindrical aperture 48. See FIG. 3. The cylindrical aperture 48 permits passage of a pin 49 therethrough. The bottom of the lid 50 includes means for accepting both ends of the pin 49 such that the movable lid 40 is permitted to rotate about the axis of the pin 49. The stationary lid portion 50 also features a plurality of rivet holes 49 that match the rivet holes defined within the crank mechanism 60. The crank mechanism 60 is attached to the lid 50 using rivets 68 or some other suitable fastener. The ends 61, 62 of the crank mechanism 60 have tabs that slide into the slot 36 of the top retainer 30 and slot of the top retainer spring 20, respectively. The crank mechanism 60 is a generally rectangular piece of metal wherein the metal is bent orthogonally upwardly, then orthogonally parallel to the rest of the crank mechanism 60 and then orthogonally downwardly toward the lid 50 such that the crank mechanism forms a plateau 63. One end 62 is also bent generally orthogonally upwardly and away from the crank mechanism 60. The crank mechanism 60 includes a pair of linearly aligned holes 65, 66, one defined within the upturned end 62 of the crank mechanism 60 and one defined within the side 64 of the plateau 63. See FIG. 3.

The linearly aligned holes 65, 66 provide an opening for a portion of a generally horizontally aligned crankshaft 70. This crankshaft 70 extends through the aligned holes 65, 66 and is functionally configured to rotate within those holes 65, 66. The crank shaft 70 is preferably fabricated of a stainless steel or polished brass but can be fabricated any material that is stiff enough so as not to deform when the crank shaft 70 is rotated. The first end 71 of the crankshaft is threaded such that when it is inserted into the side 64 of the plateau 63 of the crank mechanism, it can be secured using a nut 78. See FIG. 3. The second end 72 of the crankshaft 70 is curved orthogonally downwardly and then orthogonally parallel to the first end 71 of the crankshaft 70 to form, in effect, a step that allows for convenient manual rotation of the crankshaft 70. The first end 71 of the crankshaft 70 features a decorative handle 73. The second end 72 of the crankshaft 70 also features a decorative turning handle 75 attached using a nut 76. As previously mentioned, any material providing some insulation from the heat source is acceptable. But these inventors prefer the aesthetic appeal of an oak handle and turning handle.

The crankshaft 70 is attached to and turns a first brass gear 80. That first brass gear 80 includes teeth that meshingly engage the gear teeth of a second brass gear 90. Rotation of the first gear 80 effects a rotation of the second gear 90. The second brass gear 90 is attached to the top or uppermost portion of the stirring rod 100 using a nut 92. Referring again to FIG. 3, the second brass gear 90 rests on a brass bushing 91 that, in turn, rests on the plateau 63 of the crank mechanism 60 and is attached to the stirring rod 100 using an acorn lock nut 98. The uppermost portion of the stirring shaft 100 extends through an aperture 69 in the plateau 63 in the crankshaft 60, through the aperture 54 defined within the lid 50 and downwardly into the kettle 10. Numerous different methods and configurations for securing the stirring rod 100 vertically while permitting rotation of the stirring rod 100 are possible and only one has been mentioned. This illustration is meant to provide an example of a means for turning the stirring rod and not to limit the scope of the invention in any way. In the preferred embodiment, the stirring rod 100 comprises a generally rod-like piece of metal material of relatively stiff construction. As long as it was heat resistant, it is also to be understood that the stirring rod 100 could be fabricated from any material that does not bend or deform appreciably during normal use of the device. This could include rigid and heat resistant non-metal materials.

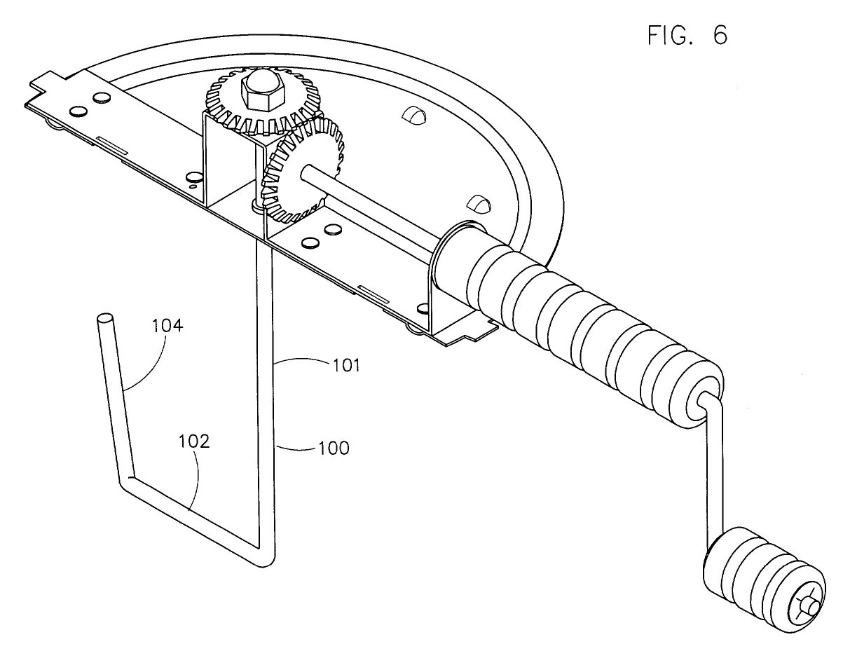

The stirring rod 100 is specifically designed to agitate unpopped and popped popcorn kernels located within the kettle 10 when the kettle 10 is placed over a heated surface, such as a stove element. With this in mind, the shape of the stirring rod 100 should, in the preferred embodiment, mirror that of the inside of the kettle 10, whatever that shape may be. For example, the stirring rod 100 could take the shape of the first embodiment depicted in FIGS. 3, 5 and 6. As shown in those figures, the stirring shaft 100 has three distinct parts. First, the stirring rod 100 includes a generally vertical and downwardly extending proximal portion 101. This proximal portion 101 should be long enough such that the stirring rod 100 reaches to the bottom surface 14 of the kettle 10. See FIG. 5. The proximal portion 101 of the stirring rod 100 is attachable by threads or other suitable means to the second gear 90 such that rotational motion of the crankshaft is translated entirely to the stirring rod 100. Second, the stirring rod 100 includes a generally horizontal central portion 102 that extends generally outwardly at a 90° angle from the stirring shaft 100 such that when the stirring shaft 100 is turned, the central portion 102 passes over the horizontal bottom 14 of the kettle 10. This is not to say that the central portion 102 needs to be in actual contact with the bottom 14 of the kettle 10 so that it presents resistance to turning of the stirring shaft 100, only that it is able to sweep things along and off of the floor 14 of the kettle 10. Third, the stirring rod 100 includes an upwardly turned distal end portion 104. The upturned distal end portion 104 is upturned at an angle to match that of the sidewall 11 of the kettle 10. In this fashion, the upturned distal end 104 moves along the continuous sidewall 11 of the kettle 10 to move popped kernels of popcorn away from the sidewall 11. In this embodiment, these inventors have found that optimum dimensioning of the stirring rod is to have a distal end 104 that extends upwardly along the bottommost 4 inches of the sidewall 11.

An alternative embodiment of the stirring shaft 100 features a means for further improving the mixing process of the popcorn while it is cooking. As previously discussed, the less dense popped popcorn theoretically ascends as it cooks and allows the denser, unpopped kernels to fall downwardly toward the heating element and pop. Unfortunately, the shape of the popped popcorn frequently prevents this process and some form of additional agitation, or mixing, is required. With this concept in mind, these inventors have provided a means for mixing popcorn located in the middle of the kettle 10.

This second embodiment of the stirring shaft 200 features a “double looped” shaft, or a shaft having multiple bends defined within it, and is formed, preferably, from a single piece of rod-like material. This double looping stirring shaft 200 actually agitates several layers of popcorn, improving the yield of popped corn over other methods. It also significantly improves the quality of popcorn coating when the popped corn is to be made into flavored corn, such as caramel corn or cheese corn, for example. The second embodiment of the stirring rod 200 provides for a unique rod design. As with the previous embodiment, the stirring rod 200 comprises a rod-like member that extends generally vertically downwardly from the lid 40, 50 of the kettle 10. The second embodiment of the stirring rod 200 provides for a first open loop 210 at a point that would be approximately midway between the kettle lid 40, 50 and the kettle floor 14 to agitate the popcorn at approximately the middle of the cooking receptacle 10. This first open loop 210 is generally formed by producing a jut out 212 and then a downward bend of slightly greater than 90° in the stirring rod 200 such that a portion 214 of the rod 200 extends outwardly toward the sidewall 11 of the kettle 10. The loop 210 is then formed by reverse 216 bending the stirring rod 200 generally downwardly at an angle slightly less than 180° and extending that portion 218 of the stirring rod 200 back toward the axial center of the kettle 10. The purpose of the jut out 212 is to insure that the lower portion 218, or second half, of the loop 210 is preferably in a distinct angular and elevational plane from the upper portion 214, or first half, of the loop 210 such that two distinct surfaces are present to agitate the popcorn.

The stirring rod 200 then extends downwardly toward the bottom 14 of the kettle 10 and may either form the configuration of the first embodiment at its distal end or have yet another loop 220 as described above. In that fashion, this second open loop 220 is generally formed by producing a downward bend of slightly greater than 90° in the stirring rod 200 such that a portion 224 of the rod 200 extends outwardly toward the sidewall 11 of the kettle 10. The second loop 220 is then formed by reverse 226 bending the stirring rod 200 generally downwardly at an angle slightly less than 180° and extending that portion 228 of the stirring rod 200 back toward the axial center of the kettle 10. The lower portion 228, or second half, of the second loop 220 is preferably in a distinct angular and elevational plane from the upper portion 224, or first half, of the loop 220 such that two distinct surfaces are present to agitate the popcorn. In either case, the bottommost portion 228 of the stirring rod 200 should sweep along the bottom 14 of the kettle 10 so that the cooked popcorn is moved away from the unpopped kernels. It should be reemphasized here that one or any plurality, or a combination, of the above features could be employed together or separately and still bring the device within the scope of the present invention.

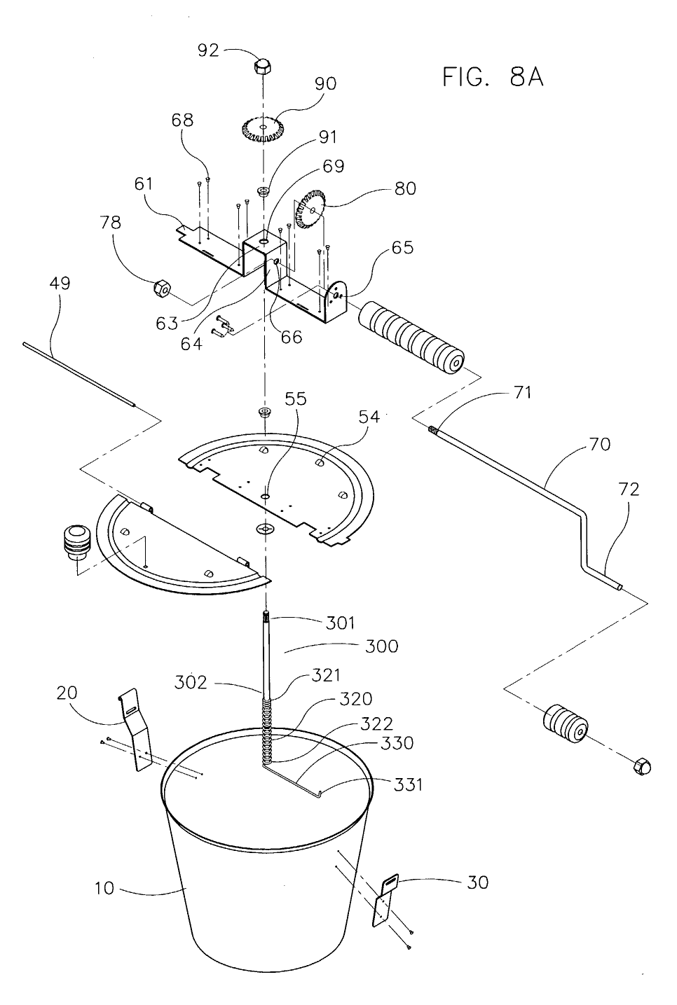

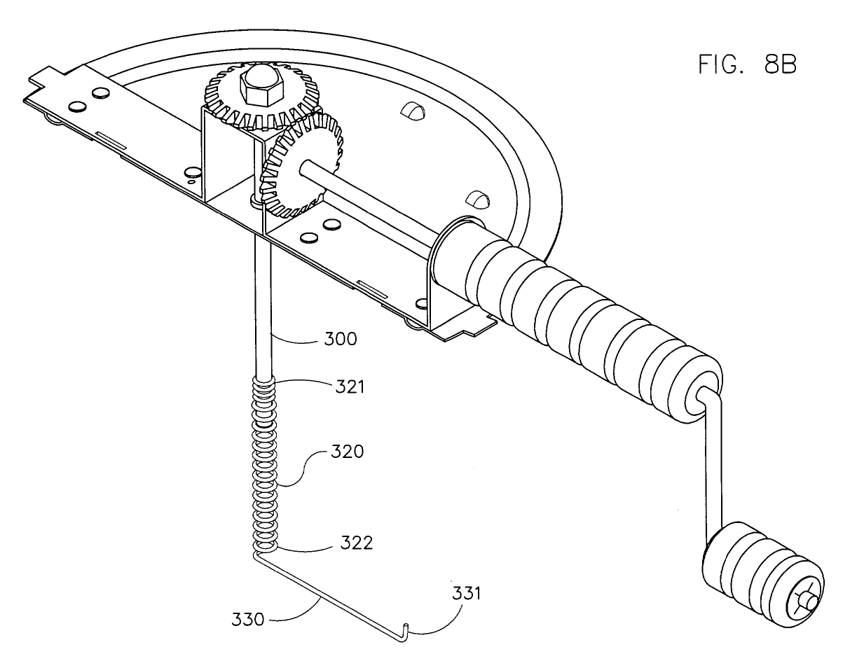

Yet another alternative embodiment of the stirring rod is shown in FIGS. 8A and 8B. This particular embodiment includes a popcorn stirring rod 300 having a first proximal end 301 that is attachable to the means for turning the popcorn stirring rod 300. The second end 302 of the popcorn stirring rod 300 is attached to the first end 321 of a helical spring 320. The second end 322 of the helical spring 320 is attached to, or is integrally formed as, a sweeping member 330. The sweeping member 330 may be simply a device that sweeps along the floor 14 of the cooking receptacle 10. The sweeping member may also feature an upturned end 331 that sweeps along the sidewall 11 of the kettle 10. The helical spring 320 provides both compression to keep the sweeping member 330 close to the bottom of the kettle 10 and torsion such that when the stirring member 300 is rotated, the sweeping member 330 will move popped kernels away from the bottom 14 of the kettle 10 and brush over the unpopped kernels so they tend to stay at or near the bottom 14 of the kettle 10.

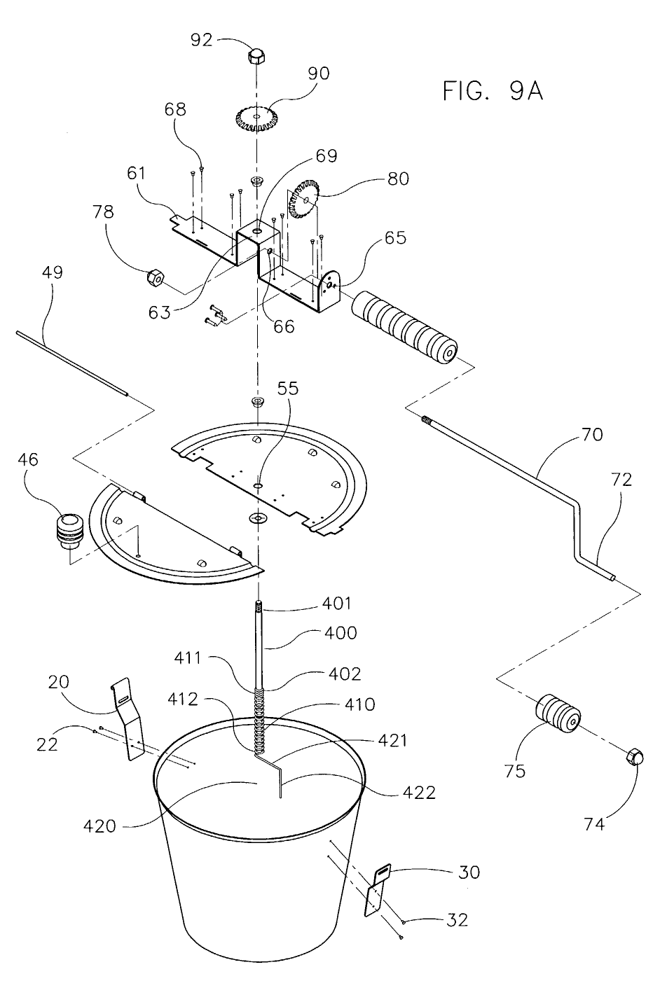

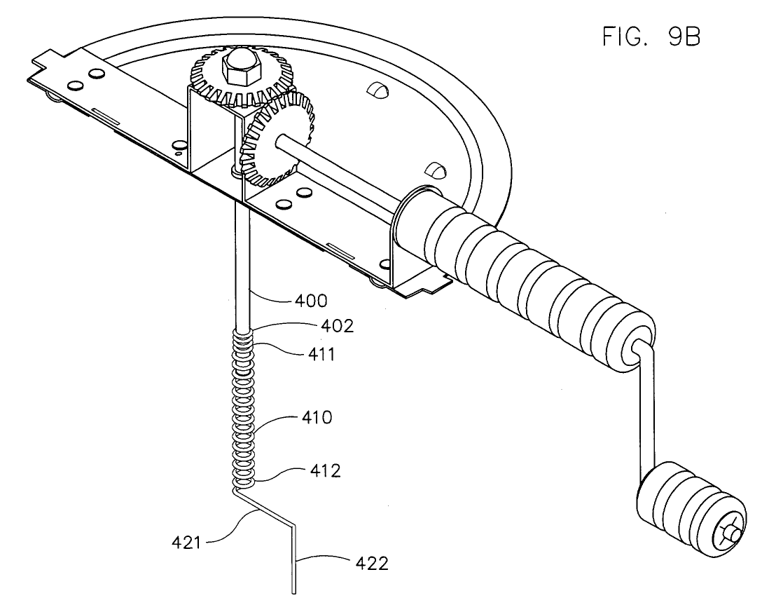

A fourth and final embodiment of the stirring rod is shown in FIGS. 9A and 9B. This final embodiment includes a stirring rod 400 having a first threaded end 401 and a second end 402. The first end 401 of the stirring rod 400 is attached to the brass gear 90, such that when the brass gear is rotated, the stirring rod 400 is rotated. The second end 402 of the stirring rod 400 is connected to the first end 411 of a helical spring 410. The helical spring 410 provides both compression to keep the sweeping member 420 close to the bottom of the kettle 10 and torsion such that when the stirring member 400 is rotated, the sweeping member 420 will move popped kernels away from the bottom 14 of the kettle 10 and brush over the unpopped kernels so they tend to stay at or near the bottom 14 of the kettle 10. The second end of the spring 411 terminates in a sweeping member 420 that has a first portion 421 and a second portion 422, set at an angle to the first portion 421 designed to sweep the popped popcorn off the bottom 14 of the kettle 10 such that the popped popcorn circulates upward and the unpopped popcorn falls downwardly to the hot surface of the bottom 14 of the kettle 10. As shown in the FIGS. 9A and 9B, when turned clockwise, the sweeping member 420 acts like an inverted plow with the tip of the V being the trailing end.

Obviously, it is within the scope of this invention to accommodate both right and left handed persons. Left-handed people are generally inclined to stir a given mechanism in the opposite direction as right handed people given no prior instruction. Therefore, it is within the scope of this invention to reverse the bend of any of the nonsymmetric stirring rods to accommodate left handed people.

Accordingly, an improved device for agitating popped and unpopped kernels has been disclosed. The device of the present invention provides a popcorn popping apparatus that is designed and constructed to recognize that overheating of the kernels occurs not only at the bottommost horizontal surface of the cooking device, but also up and along its sidewalls. The device of the present invention includes a popcorn stirring rod that is simple to produce, is less complicated than like articles of similar manufacture and that may be interchanged with other rods. The device of the present invention also provides a popcorn stirring rod that is configured in one embodiment to facilitate the coating of popcorn with flavorings or other foodstuffs as desired or required by the consumer.

Although we have very specifically described the preferred embodiments of the invention herein, it is to be understood that changes can be made to the improvements disclosed without departing from the scope of the invention. Therefore, it is to be understood that the scope of the invention is not to be overly limited by the specification and the drawings, but is to be determined by the broadest possible interpretation of the claims.

Based on the foregoing, we hereby claim as our invention:

1. A popcorn popping device that comprises
a popcorn containing kettle, said kettle including a generally circular and continuous sidewall, an upper circular opening, a bottom floor and a bottom circular edge defined between the sidewall and the floor,
a stirring rod extending generally vertically and downwardly into said kettle, said stirring rod including a proximal portion, a central portion and a distal portion, and
means for effecting rotation of the stirring rod within the kettle,
wherein the central stirring rod portion passes over the bottom floor of the kettle and the distal stirring rod portion passes over a portion of the kettle sidewall when the proximal portion of the stirring rod is rotated.

2. The popcorn popping device of claim 1 wherein the rotation effecting means includes a stirring rod handle and means for translating motion from the stirring rod handle to the stirring rod proximal portion.

3. The popcorn popping device of claim 2 wherein the rotation effecting means further includes a pair of meshingly engageable gears and a gear support.

4. The popcorn popping device of claim 3 including a kettle cover and said gear support is mountable to a portion of said kettle cover.

5. The popcorn popping device of claim 1 wherein the central portion of said stirring rod extends axially outwardly from said proximal stirring rod portion.

6. The popcorn popping device of claim 1 wherein the central portion of said stirring rod extends axially outwardly from said proximal stirring rod portion and generally at an angle of 90° relative to it.

7. The popcorn popping device of claim 5 wherein the distal portion of said stirring rod extends upwardly from said central stirring rod portion.

8. The popcorn popping device of claim 6 wherein the distal portion of said stirring rod extends upwardly from said central stirring rod portion.

9. The popcorn popping device of claim 1 wherein said popcorn containing kettle is formed in an inverted conical shape wherein said upper circular opening is of a diameter that is greater than that of the bottom circular edge.

10. The popcorn popping device of claim 9 wherein the sidewalls slope outwardly from the bottom circular edge at an acute angle relative to the horizontal.

11. The popcorn popping device of claim 10 wherein the central portion of said stirring rod extends axially outwardly from said proximal stirring rod portion.

12. The popcorn popping device of claim 10 wherein the central portion of said stirring rod extends axially outwardly from said proximal stirring rod portion and generally at an angle of 90° relative to it.

13. The popcorn popping device of claim 11 wherein the distal portion of said stirring rod extends upwardly from said central stirring rod portion in approximately the same angle as the sidewall relative to the horizontal.

14. The popcorn popping device of claim 12 wherein the distal portion of said stirring rod extends upwardly from said central stirring rod portion in approximately the same angle as the sidewall relative to the horizontal.

15. A popcorn popping device that comprises
a popcorn containing kettle, said kettle including a generally circular and continuous sidewall, an upper circular opening, a bottom floor and a bottom circular edge defined between the sidewall and the floor,
a stirring rod extending generally vertically and downwardly into said kettle, said stirring rod including a proximal portion, a central portion and a distal portion, and
means for effecting rotation of the stirring rod within the kettle,
wherein the central stirring rod portion includes an axially perpendicular member extending outwardly therefrom and the distal stirring rod portion passes over the bottom floor of the kettle when the proximal portion of the stirring rod is rotated.

16. The popcorn popping device of claim 15 wherein the rotation effecting means includes a stirring rod handle and means for translating motion from the stirring rod handle to the stirring rod proximal portion.

17. The popcorn popping device of claim 16 wherein the rotation effecting means further includes a pair of meshingly engageable gears and a gear support.

18. The popcorn popping device of claim 17 including a kettle cover and said gear support is mountable to a portion of said kettle cover.

19. The popcorn popping device of claim 15 wherein the member extending outwardly from the central portion of said stirring rod includes a bend in the rod outwardly and then a reverse bend inwardly to form a member integral therewith.

20. The popcorn popping device of claim 15 wherein the distal portion of said stirring rod includes a bend in the rod outwardly and then a reverse bend inwardly to form a member integral therewith.

21. The popcorn popping device of claim 20 wherein the outwardly extending distal portion of said stirring rod and the outwardly extending member of said central stirring rod portion are disposed axially opposite from one another.

22. A stirring rod for use with a popcorn popping kettle having a floor and at least one continuous sidewall, said stirring rod comprising
a generally vertical section that descends to the floor of the kettle,
a second portion, generally perpendicular to the first, extending radially outwardly from the vertical section along the floor of the kettle, and
a third portion, turned upwardly at the same or similar angle that the continuous sidewall makes with the floor.

23. A stirring rod for use with a popcorn popping kettle having a floor, a top, a center and at least one continuous sidewall, said stirring rod comprising
a continuous member extending vertically downwardly from the top of center of the kettle,
said continuous member being formed into a first loop extending to the sidewall of the kettle and returning to the center of the kettle,
said continuous member further descending to nearly the floor of the kettle, and
said continuous member forming a second loop extending outwardly towards the sidewall of the kettle and returning to the center of the kettle.

24. A stirring rod for use with a popcorn popping kettle having a floor and at least one continuous sidewall, said stirring rod comprising
a rod member having a first end and a second end,
a helical spring having a first end attached to the second end of the rod member and a second end, said spring being generally collinear with the rod member and said helical spring being capable of providing both pressure against the floor of the kettle and torsion, and
a member for sweeping the floor of the kettle, said member being attached to or forming an integral part of said spring.

25. The stirring rod of claim 24 wherein said sweeping member has a first portion positioned perpendicular to the helical spring adjacent the floor of the kettle, and said sweeping member further includes a second portion generally perpendicular to the first portion, said second portion being used for sweeping the continuous sidewall of the kettle.
